(19) United States
(12) Patent Application Publication
(10) Pub. No.: US 2010/0115419 A1
(43) Pub. Date: May 6, 2010

(54) GRATITUDE PROVIDING SYSTEM AND GRATITUDE PROVIDING METHOD

(75) Inventor: Takayuki Mizuno, Tokyo (JP)

Correspondence Address: MAIER & MAIER, PLLC, 1000 DUKE STREET, ALEXANDRIA, VA, 22314, US

(73) Assignee: CHAO Inc., Tokyo (JP)

(21) Appl. No.: 12/529,797

(22) PCT Filed: Mar. 8, 2007
(86) PCT No.: PCT/JP2007/054594

§ 371 Date: Sep. 3, 2009

(51) Int. Cl. G06F 3/00

(52) U.S. Cl. 715/745

(57) ABSTRACT

A gratitude providing system is configured to present gratitude expressed as visual value information (chao) to the other user (gratitude presentee) who has given a moved or kind act. The gratitude providing system specifies attribute items (job) owned by the user of the gratitude presentee; transmits predetermined chao determined by the user from a communication terminal device; stores the chao, which a user eventually has owned, at a chao passbook in connection with the job owned by the user; sets each user job level in accordance with each user job recorded and held at the chao passbook and each user chao quantity or a presenting frequency, and publicly discloses this set job level of the user through a communication network.

### RELATED APPLICATION

The present invention is the national stage application of and claims priority to international application No.: PCT/JP2007/054594, filed on Mar. 8, 2007, the disclosure of which is incorporated by reference herein in its entirety.

### TECHNICAL FIELD

The present invention relates to a gratitude providing system and a gratitude providing method for exchanging and storing, in the form of visual value information, appreciation to someone who has given an impressive or kind act and the feeling of gratitude to an acquaintance for backup or the like, for realizing own dreams, wishes and something wanted to do.

### BACKGROUND ART

Conventionally, it is the custom in the real world to say “thank you” to someone who has given an impressive or kind act, and express gratitude to an acquaintance for backup or the like by expressing appreciation in words, giving a gift, and sometimes giving money.

On the other hand, at present, it becomes possible to exchange value information corresponding to a gift or money by the use of communication terminals, contactless IC cards and the like capable of storing, transmitting and receiving electronic information such as electronic money, and for example systems have been developed which make it possible to move value information owned by one user to a storage area in the communication device used by another user in much the same way as a banknote possessed by one user is given to another user (for example, refer to Patent Document 1).
[Patent Document 1] Japanese Patent Published Application No. 2007-41954

### DISCLOSURE OF THE INVENTION

### Problems to be Solved by the Invention

However, since the exchange of electronic value information as described above is simply a transaction of money in the real world, it is difficult to express feelings through this exchange. In addition to this, even if some feelings can be expressed by sending electronic money together with words, this action is closed on the spot between users, but cannot become a global link for realizing the dream or wish of the presentee.

On the other hand, in a virtual real world such as the Internet, the so-called “Web 2.0” thinking is spreading. This “Web 2.0” refers to the concept that, while users had received information in a one way direction from service providing sites in the conventional Web, the users become service providing sides by participating social networking such as blogs or the like as nodes and links of information flows to contribute development of content.

In accordance with this “Web 2.0”, there is a possibility that a user becomes famous or highly appraised and has a dream or wish come true by communication, globally extended links and closing the links on the Internet.

Taking into consideration the above circumstances, it is an object of the present invention to provide a system which makes it possible to exchange and store, in the form of visual value information, the feeling of gratitude to someone who has given an impressive or kind act in the real world, so that the links among users can be globally developed and made closely related to each other and thereby “dreams”, “wishes” and “something wanted to do” of the users can be realized.

### Solution to Problems

In order to accomplish the object as described above, the present invention provides a gratitude providing system among users for giving visual value information representing the feeling of gratitude to another user who has given an impressive or kind act, and comprises the following elements:

(1) a gratitude providing unit which is a communication terminal used by each user and serves to transmit a predetermined quantity of value information which is determined by identifying attribute items which belong to the another user as a gratitude presentee;

(2) a passbook management unit located in a communication network, and operable to record and hold the value information given and accepted among the users through the gratitude providing unit in association with the attribute items belonging to the respective users;

(3) a profile management unit located in the communication network, and operable to set the attribute item of each user and the evaluation level of each user in accordance with the gratitude acceptance frequency and the quantity of the value information in association with the attribute item, or the number of users involved in the exchange of the value information, as recorded and held in the passbook management unit; and

(4) a user page publishing unit operable to publish the evaluation levels of the respective users which are set by the profile management unit through the communication network.

On the other hand, the present invention provides a gratitude providing method among users for giving visual value information representing the feeling of gratitude to another user who has given an impressive or kind act, and comprises the following steps:

(1) a step of transmitting a predetermined quantity of value information which is determined by identifying attribute items belonging to the another user as a gratitude presentee through a gratitude providing unit which is a communication terminal used by each user;

(2) a step of recording and holding the value information given and accepted among the users through the gratitude providing unit in association with the attribute items belonging to the respective users by a passbook management unit located in a communication network;

(3) a step of setting the attribute item of each user and the evaluation level of each user in accordance with the gratitude acceptance frequency and the quantity of the value information in association with the attribute item, or the number of users involved in the exchange of the value information, as recorded and held in the passbook management unit, by a profile management unit located in the communication network; and

(4) a step of publishing the evaluation levels of the respective users which are set by the profile management unit through the communication network by a user page publishing unit located in the communication network.

In accordance with the present invention as described above, it is possible to express the feeling of gratitude such as routinely saying “thank you” by the value information to the gratitude presentee, accumulate the value information in the passbook management unit, and evaluate the user who has accepted gratitude in accordance with the gratitude acceptance frequency and the quantity of the value information in association with each attribute item, or the number of users involved in the exchange of the value information. This evaluation is published through the communication network as evaluation levels, and thereby the exchange of the feeling of “thank you” accumulated on an individual basis is internationally delivered as global information to increase the possibility that “dreams” and “wishes” of users come true.

Meanwhile, the evaluation levels may be “job levels” on the basis of the density of links among users, for example, the quantity and gratitude acceptance frequency (the number of times of accepting gratitude) of each attribute items, and “stock epithet levels” on the basis of the spread of links among users, for example, the number and locations of presenters who have given gratitude.

Preferably, in the invention as described above, when the value information is transmitted, the gratitude providing unit can add additional data such as character data, image data or the like. In this case, it is possible to use a variety of ways for more appropriately expressing the feeling of gratitude to the gratitude presentee.

Preferably, in the invention as described above, a value information purchase unit is provided which sells the value information through the communication network, makes the gratitude providing unit accumulate the value information, and performs a billing process corresponding to the sales of value information. In this case, the value information for giving gratitude can easily be obtained such that the user-friendliness can be improved.

Preferably, in the invention as described above, a search unit is provided for searching the pages of the users with the evaluation levels and other profiles of the users as search terms. In this case, it is possible to search for users by the use of a variety of search terms and easily make friends and like-minded people.

Also, when publishing profiles, while ranking the evaluation levels of users as described above, higher users may be displayed in a list. This ranking can be performed in accordance with the job level and the stock epithet level as described above, independently for each area, i.e., each nation, each district and so forth.

Preferably, in the invention as described above, the value information has a value which is exchangeable with goods or services. In this case, since the value information given as gratitude can be converted into goods or services, the feeling of gratitude can be objectified on the basis of the will of the user as the presenter and the will of the user as the presentee.

Furthermore, in the invention as described above, when accepting value information from the presenter, part of the accepted value information can be shared with another user who is randomly selected. In this case, the value information accepted as gratitude can be “shared” with another user who is not related, and the feeling of gratitude such as “thank you” accepted by the gratitude presentee can be shared with another user, who is not related, to trigger expansion of links among users.

### EFFECTS OF THE INVENTION

As has been discussed above, in accordance with the present invention, it is possible to exchange and store, in the form of visual value information, the feeling of gratitude such as “thank you” to someone who has given an impressive or kind act in the real world, so that the links among users can be globally developed and made closely related to each other and thereby “dreams”, “wishes” and “something wanted to do” of the users can be realized.

### BRIEF DESCRIPTION OF THE DRAWINGS

FIG. 1 is a view for schematically explaining the configuration of the gratitude providing system in accordance with an embodiment.

FIG. 2 is a functional block diagram for showing the respective modules formed by a server group 5 and the relationship between these modules and the user terminals in accordance with the embodiment.

FIG. 3 is a block diagram for showing the internal structure of a value information setting unit 103 in accordance with the embodiment.

FIG. 4 is an explanatory view for schematically showing the configuration of the screen when performing a gratitude process with a communication terminal in accordance with the embodiment.

FIG. 5 is an explanatory view for schematically showing the configuration of the screen when viewing a chao passbook with the communication terminal in accordance with the embodiment.

FIG. 6 is an explanatory view for schematically showing the configuration of the screen when viewing the content of the chao passbook with the communication terminal in accordance with the embodiment.

FIG. 7 is an explanatory view for schematically showing the configuration of the screen when setting the publication information of the member page with the communication terminal in accordance with the embodiment.

FIG. 8 is an explanatory view for schematically showing the configuration of the screen when charging the communication terminal with chao in accordance with the embodiment.

FIG. 9 is a flow chart for showing the operation of the gratitude providing system in accordance with the embodiment.

FIG. 10 is an explanatory view for showing the general outline of a gratitude sharing process in accordance with the embodiment.

FIG. 11 is an explanatory view for showing the general outline of the process of updating the chao passbook in accordance with the embodiment.

FIG. 12 is an explanatory view for showing the general outline of the process of updating the evaluation levels (the job levels and stock epithet levels) in accordance with the embodiment.

### REFERENCE SIGNS LIST

chao . . . value information
1 . . . user (gratitude presenter)
1a-3a . . . communication terminal
2 . . . user (gratitude presentee)
3 . . . users (third party user)
4 . . . communications network
5 . . . server group
6 . . . purchase server
51 . . . chao passbook server
52 . . . account/profile management server
53 . . . member page delivery server
54 . . . user management database
101 . . . manipulation unit
102 . . . manipulation signal acquisition unit
103 . . . value information setting unit
103a . . . user information adding unit
103b . . . additional data adding unit
103c . . . gratitude information producing unit
103d . . . attribute item selecting unit
103e . . . gratitude presentee selecting unit
103f . . . gratitude presentee information referring unit
103g . . . value information input unit
104 . . . display unit
105 . . . display data generation unit
106 . . . communication interface
107 . . . value information accumulation management unit
501 . . . profile management unit
502 . . . passbook management unit
503 . . . value information communication unit 503
504 . . . communication interface
505 . . . database search unit
506 . . . user page publishing unit

### BEST MODE FOR CARRYING OUT THE INVENTION

(Configuration of Gratitude Providing System)

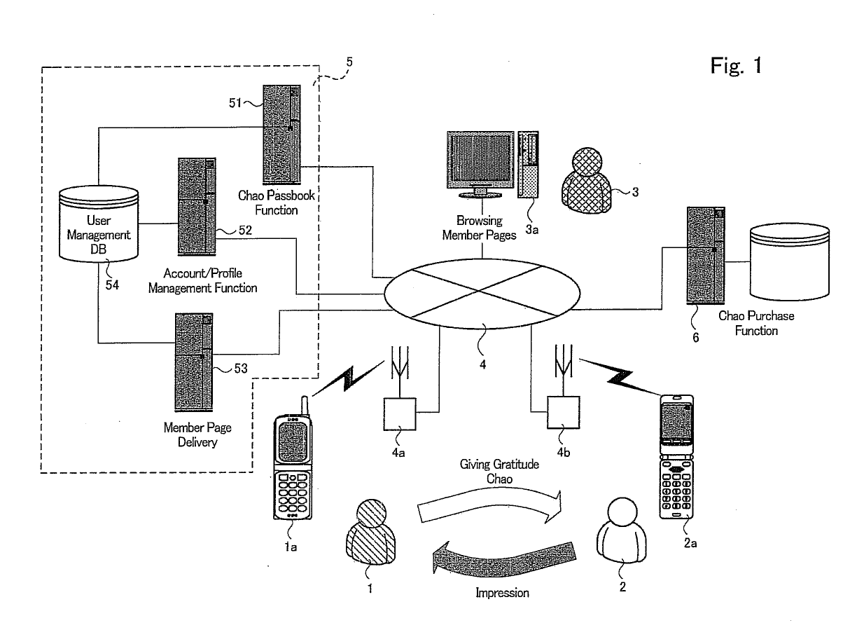

An embodiment of the present invention will be explained with reference to the drawing. FIG. 1 is a view for schematically explaining the configuration of the gratitude providing system in accordance with the present embodiment.

As shown in the same figure, the gratitude providing system is a network system for performing “gratitude provision” as chao in the form of visual value information representing the feeling of appreciation between users 1 and 2, i.e., from one user (e.g., the user 1) to the other user (e.g., the user 2) who has given an impressive or kind act. In the case of the present embodiment, this value information chao has a value which is exchangeable with goods or services, such that the value information as “accepted gratitude” can be converted into the form of goods or services.

The gratitude providing system of the present embodiment is generally composed of a server group 5 for providing the gratitude providing service, communication terminal devices 1a to 3a which are used by users 1 to 3 respectively, and a purchase server 6 for purchasing chao.

The communication terminal devices 1a and 2a are communication terminals which are individually used by the users and serve as portable telephone equipments utilizing radio communication channels for communication with relay points such as base stations 4a and 4b of a communication network 4 such that the users can receive communication services such as voice conversation, data communication and so forth during moving. The communication methods for this type of cellular phones includes, for example, FDMA, TDMA, CDMA, W-CDMA, PHS (Personal Handyphone System) and so forth. Also, the cellular phone is provided with functions such as a digital camera function, an application software execution function, and a GPS function, and serves also as a personal digital assistant (PDA).

Then, the communication terminal devices 1a and 2a are provided with the function as a gratitude providing unit for identifying the attribute items of another user who is a gratitude presentee and transmitting a predetermined quantity of chao (value information) which is determined by the user, and the function of referring to the given chao with a chao passbook. The gratitude providing function and the chao passbook review function are implemented with a browser function. This browser function is provided by application software for browsing Web pages, and capable of downloading HTML (HyperText Markup Language) files, image files, music files and the like, parsing the layout to display and play back them. In addition, this browser function enables the user to transmit data to a Web server by the use of a form, and run application software which is written in JavaScript (Java is a registered trademark), Flash, Java and so forth.

Meanwhile, in the case of the present embodiment, the terminal devices used by the users 1 and 2 are described as cellular phones. The present invention is not limited thereto. The terminal devices may be general purpose computers such as personal computers or dedicated apparatuses such as game apparatuses. In the case where the terminal device is a general purpose computer, the gratitude providing unit of the present invention can be implemented with a dedicated application which is run on the personal computer or an add-on program which is plugged in a browser software.

The communication network 4 is a distributed IP communication network which is constructed by connecting a variety of communication lines (telephone line, ISDN line, public network such as ADSL line, dedicated communication line, and radio communication network) to each other by the use of the communication protocol TCP/IP. This IP network includes a LAN such as a home network, an intranet (a network within a company) based on 10 BASE-T, 100 BASE-TX or the like.

Meanwhile, in the case of the present embodiment, the terminal used by the user 3 is a general purpose personal computer such as a personal computer. This personal computer is capable of performing the same functionality as the communication terminal devices 1a and 2a by the use of a browser software which is run by the personal computer.

The server group 5 is a group of server devices which are provided with a variety of functions respectively and share a user management database 54 in which the registration information of all users is stored for making it possible to provide an individual service for each user. More specifically speaking, this server group 5 includes a chao passbook server 51, an account/profile management server 52 and a member page delivery server 53 as main components.

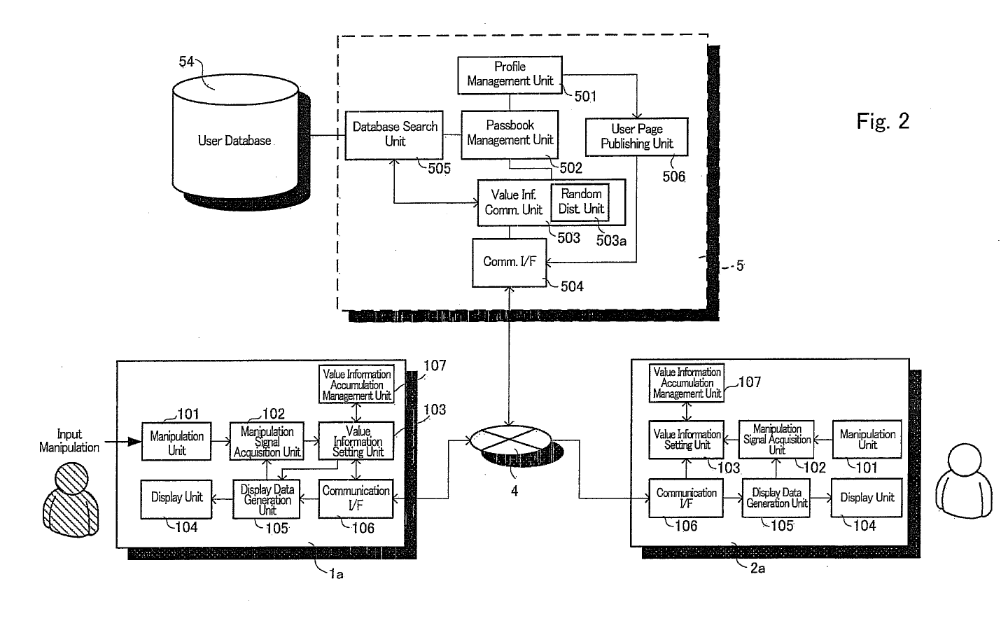

The server group 5 shares a communication capability and a database search capability, and serves as an cooperative system. FIG. 2 is a functional block diagram for showing the respective modules formed by the server group 5 and the relationship between these modules and the user terminals. Meanwhile, the term “module” used in this explanation is intended to encompass any function unit capable of performing predetermined operations, as implemented with hardware such as a device or an apparatus, software capable of performing the functionality of the hardware, or any combination thereof.

As shown in FIG. 2, the server group 5 is provided with, as its function blocks, a communication interface 504, a value information communication unit 503, a passbook management unit 502, a profile management unit 501, a user page publishing unit 506 and a database search unit 505.

The communication interface 504 is a module for connecting with the communication network 4 and transmitting and receiving data. The value information communication unit 503 acquires the information about chao exchanged between users.

The value information communication unit 503 reflects the variation of the chao owned by the users in the user management database 54 through the database search unit 505, and instructs the passbook management unit 502, the profile management unit 501 and the like to perform the processes relating to the exchange of chao.

Furthermore, the value information communication unit 503 is provided with a “gift sharing function” for giving some of chao accepted as gratitude to other users randomly selected when the chao is accepted as gratitude from the presenter. Specifically speaking, the gift sharing function is performed by a random distribution unit 503a.

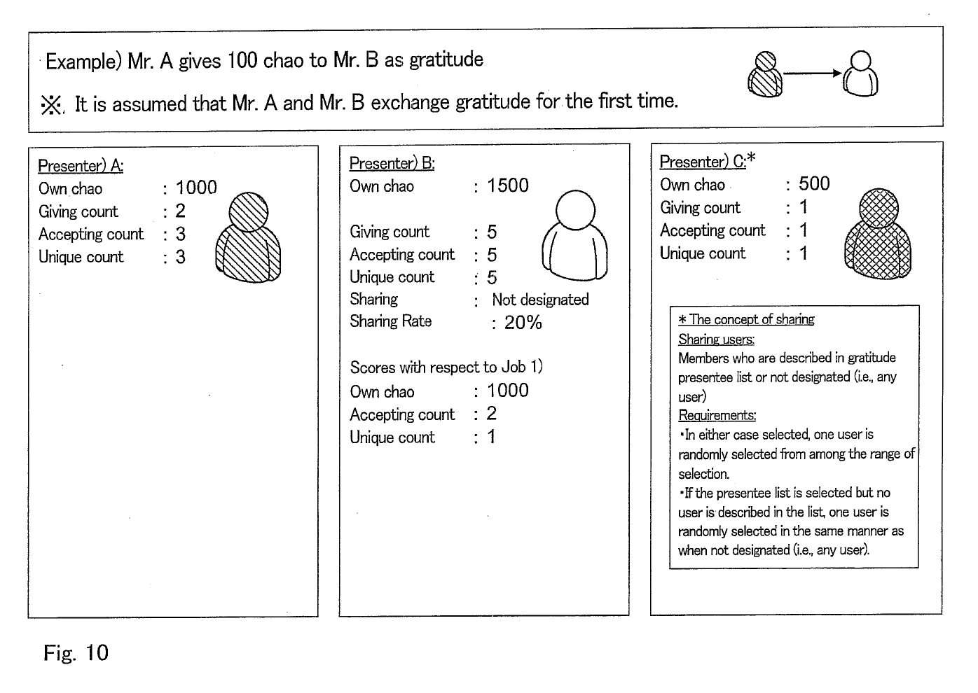

The random distribution unit 503a can be used to register a user group (group of two or more users) designated by the user as a gratitude presentee list, and serves to distribute some of the accepted chao to the members (sharing users) registered randomly selected from a gratitude presentee list each time the user accepts gratitude in accordance with a “gift sharing setting (sharing proportion of accepted chao)” determines by the user as illustrated in FIG. 10. At this time, if the number of members in the gratitude presentee list is zero, the gift sharing is performed to users randomly selected from among all the users. Incidentally, while the gift sharing users are limited to the members in the gratitude presentee list in this example, the range of random selection may not be limited to a certain user group but may be set to all the users.

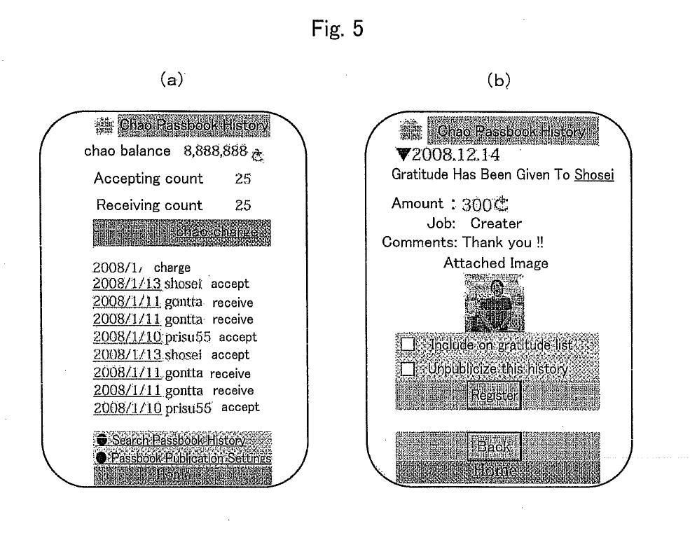

The passbook management unit 502 is mainly implemented with the chao passbook server 51, and is a module for recording and storing chao given and accepted between users through the gratitude providing unit (the communication terminal device la) and owned by each user in the form of a passbook as shown in FIGS. 5(a) and (b) in association with the attribute items (jobs) of each user. Incidentally, FIG. 5(a) shows the top page of the chao passbook in which the exchange history of chao in the chao passbook is displayed in a list which can be clicked to drill down the detailed page as shown in FIG. 5(b). Also, the top page includes a link to a page in which chao can be charged. The purchase server can be accessed through the link.

The profile management unit 501 is implemented mainly with the account/profile management server 52, and serves as a module for managing the profile of each user. This profile includes the jobs of each user, and the evaluation levels of each user in accordance with the gratitude acceptance frequency and the quantity of chao stored in association with each job, or the number of users involved in the chao exchange, as recorded and held in the chao passbook server 51.

In the case of the present embodiment, as the evaluation levels, there are “job levels” on the basis of the density of links among users, for example, the quantity and gratitude acceptance frequency (the number of times of accepting gratitude) of each attribute items, and “stock epithet levels” on the basis of the spread of links among users, for example, the number of presenters who have given gratitude (the number of all the unique users).

More specifically speaking, while the occupations, characters and skills of each user are defined as attribute items (jobs) as shown in Table 1, the job levels are numeric values by which the achievement degrees of the respective jobs are represented. These jobs are enumerated in advance by the profile management unit 501, and each user can arbitrarily select a plurality of items from the enumerated jobs. Then, the variation rates of the job levels (degrees of version-up difficulty) may be set up for the respective jobs or levels. Also, it is possible to change the balance between the quantity of chao and the number of times of accepting gratitude as the factor in raising the levels, depending upon the respective jobs or levels. Meanwhile, in the case of the present embodiment, the job level is evaluated only on the basis of the history of chao acceptance, but never lowered even when the accumulated chao is consumed thereafter.

The stock epithet level is just like a certain kind of title, as shown in Table 2, which is rated on the basis of the number of users (the number of the unique users) corresponding to the number of links formed when the chao is exchanged, and the stock epithet is laid open to be added to the user's name.

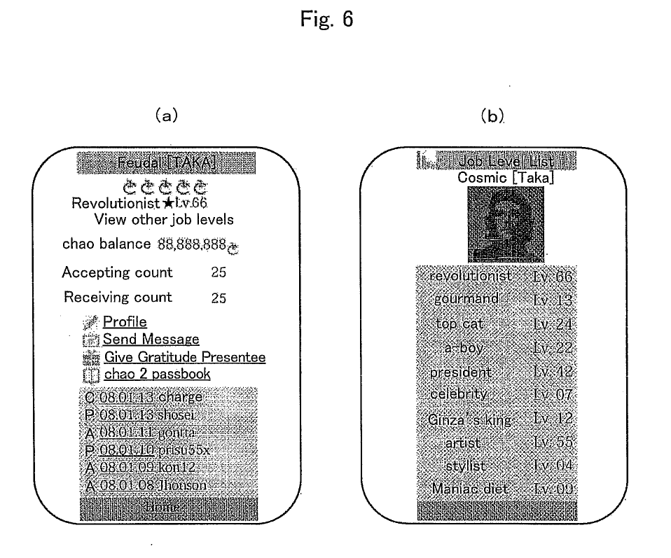

Then, the stock epithet level and the job level are displayed as the title of the profile of the member page as illustrated in FIG. 6(a). In the case of the present embodiment, the job having the highest level is displayed as the title, and this job displayed as the title is switched in accordance with the variation of the job levels.

Also, as shown in the same figure (b), each user can select a plurality of jobs in his profile, and when chao is accepted as gratitude, the presenter is asked to select which job corresponds to the gratitude. Meanwhile, in the case of the present embodiment, when a plurality of jobs are displayed as illustrated in the same figure (b), only the jobs ranked in the top 10 are extracted and displayed.

TABLE 1

| Category Name | Job Name |
|---|---|
| General | gentleman |
| | devoted husband |
| | healing-type |
| | leader |
| Gourmet | cook |
| | gourmand |
| | sommelier |
| | drinker |
| Art, Fashion | artist |
| | designer |
| | musician |
| | creater |
| Hobby | nerd |
| | film critic |
| | fighter |
| | athlete |
| Academics | teacher |
| | doctor |
| | inventor |
| | revolutionist |
| Mystical | wizard |
| | gambler |
| | alien |
| | romantic |

TABLE 2

| Stock Epithet | Unique |
|---|---|
| Beginner | 1 |
| Your | 10 |
| Neighborhood | 50 |
| Japanese | 100 |
| World' s | 1000 |
| Solar system's | 10000 |
| Galactic | 100000 |
| CHAO! God | 1000000 |

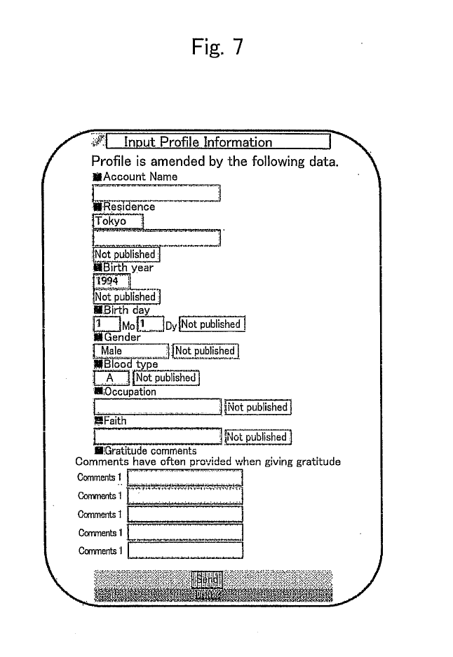

In addition, as shown in FIG. 7, each item of this profile can be set to be public or private by user's operation. Then, the profile as set up is published as a member page through the user page publishing unit 506.

The user page publishing unit 506 is implemented mainly with the member page delivery server 53, and serves as a module for publishing the user information which is accumulated in the user management database 54 as member pages and chao passbooks which are generated by the profile management unit 501 and the passbook management unit 502 respectively through the communication network 4.

Specifically describing, this user page publishing unit 506 is implemented as a Web server function. This Web server function is implemented with a server computer or software capable of performing the functionality of the server computer for performing information transmission of HTML (HyperText Markup Language) files, image files, music files and the like in a document system such as WWW (World Wide Web), and serves to accumulate information such as HTML files and images, and transmit the member pages and chao passbooks as described above in response to requests from client software such as Web browsers through the communication network 4.

Also, when publishing the profiles, this user page publishing unit 506 is provided with a ranking function for providing the rankings of the evaluation levels of the users (job levels and stock epithet levels), and displaying a list of highly ranked users. This ranking can be performed in accordance with the job level and the stock epithet level as described above, independently for each area, i.e., each nation, each district and so forth.

The user page publishing unit 506 is provided further with a mail delivery server function for making it possible to access this mail delivery server function and perform the transmission and reception of messages between users by clicking a link “Send A Message” shown in FIG. 6(a).

Each of the communication terminal devices 1a and 2a is provided with a manipulation unit 101, a manipulation signal acquisition unit 102, a display unit 104, a display data generation unit 105, and a communication interface 106 for serving as a module for providing usual communication capability.

The manipulation unit 101 is a module for inputting manipulation signals through dialing buttons, a jog dial, a touch panel and so forth. The manipulation signal acquisition unit 102 is a module for acquiring and analyzing signals generated in accordance with user's manipulation through the manipulation unit 101.

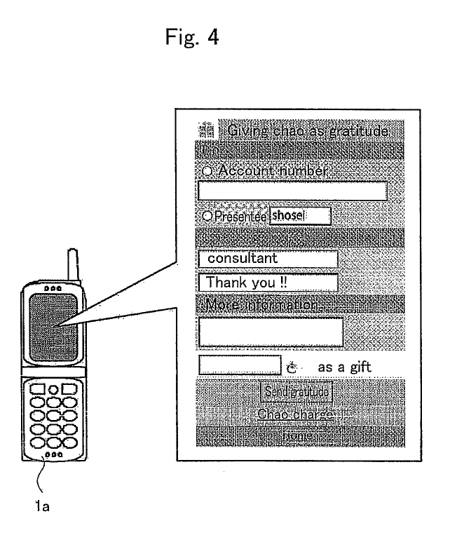

The communication interface 106 is a module for transmitting and receiving data through the communication network 4 by radio communication, outputs display data as received to the display data generation unit 105, and outputs the information about the value information (chao) to a value information setting unit 103. The display data generation unit 105 converts the display data received through the communication interface 106 into image signals which can be displayed by the display unit 104, and outputs the image signals to the display unit 104. The display unit 104 is a display device such as a liquid crystal device, and serves to display a GUI (Graphical User Interface) as illustrated in FIG. 4.

Also, the manipulation signal acquisition unit 102 receives a control signal from the display data generation unit 105 and acquires the manipulation signal on the basis of this control signal in order to link the manipulation through the manipulation unit 101 to the image displayed on the display unit 104.

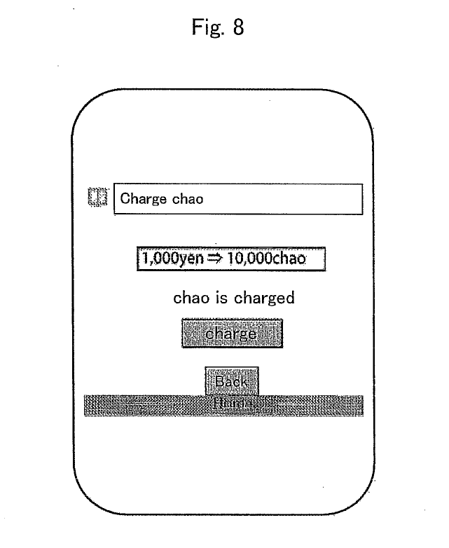

A value information accumulation management unit 107 is a storage unit for accumulating value information, and provided with the function of accepting (receiving) and paying (transmitting) value information through a near field contactless communication technique or the communication interface 106. In the case of the present embodiment, the value information chao is sold through a communication network such that chao can be purchased (charged) and accumulated in the value information accumulation management unit 107 as illustrated in FIG. 8. Selling chao is performed by the purchase server 6, which serves to perform the billing process for the value information chao. The billing payment may be collected together with the telephone bill of the cellular phone, or by any method of payment (credit card, payment at convenience store) through a financial institution and so forth. telephone charge

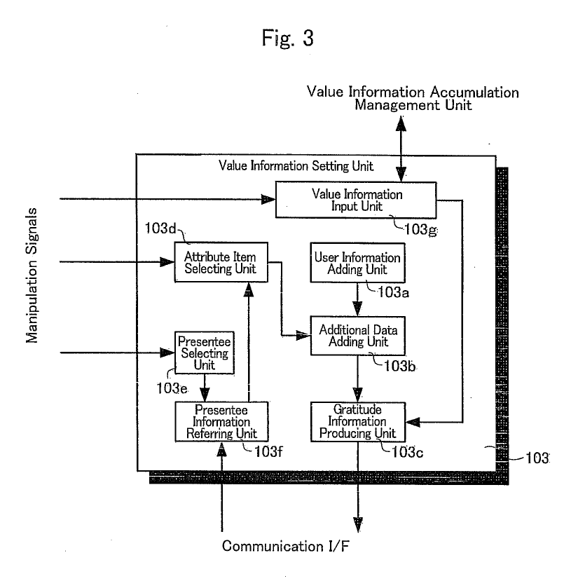

The communication terminal devices 1a and 2a used by the users are provided with the value information setting unit 103 and the value information accumulation management unit 107 as a module for presenting gratitude. FIG. 3 is a block diagram for showing the internal structure of the value information setting unit 103.

As shown in the same figure, the value information setting unit 103 is provided with a user information adding unit 103a, an additional data adding unit 103b, a gratitude information producing unit 103c, an attribute item selecting unit 103d, a gratitude presentee selecting unit 103e, a gratitude presentee information referring unit 103f, and a value information input unit 103g.

The value information input unit 103g is a module for inputting the quantity of chao as gratitude in accordance with user's operation. The input value information is transmitted to the gratitude information producing unit 103c.

The gratitude presentee selecting unit 103e is a module for identifying a gratitude presentee in accordance with user's operation. The gratitude presentee selecting unit 103e is provided with the function as search means for searching the pages of the respective users with the user's profiles (inclusive of the job levels) as search terms. This search function makes it possible to interrogate the account/profile management server 52 with a search term through the gratitude presentee information referring unit 103f, such that, when the gratitude presentee is determined, a list of gratitude presentee candidates is displayed.

The information about the gratitude presentee which is identified by the gratitude presentee selecting unit 103e (i.e., the account number, user name, handle name, ID, telephone number and so forth) is transmitted to the gratitude presentee information referring unit 103f. The gratitude presentee information referring unit 103f is a module for acquiring the user information about the gratitude presentee as identified, and refers to the user information about the gratitude presentee by exchanging data with the account/profile management server 52. The information referred to and acquired of the gratitude presentee is transferred to the attribute item selecting unit 103d.

The attribute item selecting unit 103d is a module for selecting attribute items (jobs) relating to gratitude in response to the user operation. The gratitude presentee selecting unit 103e displays the attribute items (jobs) of the gratitude presentee acquired by the gratitude presentee information referring unit 103f on the display unit 104 in order to enable selection thereamong. By this configuration, the user can select a job from among the selectable jobs of the gratitude presentee. The job selected through the attribute item selecting unit 103d is transmitted to the gratitude information producing unit 103c and added to gratitude information.

The additional data adding unit 103b is a module for adding the selected attribute item (job) and other attached data (character data, image data or the like) to the value information chao relating to gratitude and input through the value information input unit 103g.

The user information adding unit 103a is a storage unit for storing and holding the identification information (i.e., the user name, handle name, ID, telephone number and so forth) of the user using the terminal device, and transmits the user information to the additional data adding unit 103b in order to add the user information of the user using the terminal device as additional data to the gratitude information for giving chao.

The gratitude information producing unit 103c is a module for generating gratitude information by connecting the user information of the presenter, the selected attribute items and the additional data to a predetermined quantity of the value information chao which is input through the value information input unit 103g, and the gratitude information is transferred to the communication interface 106 and transmitted to the server group 5 through the communication interface 106.

(Method of Providing Gratitude)

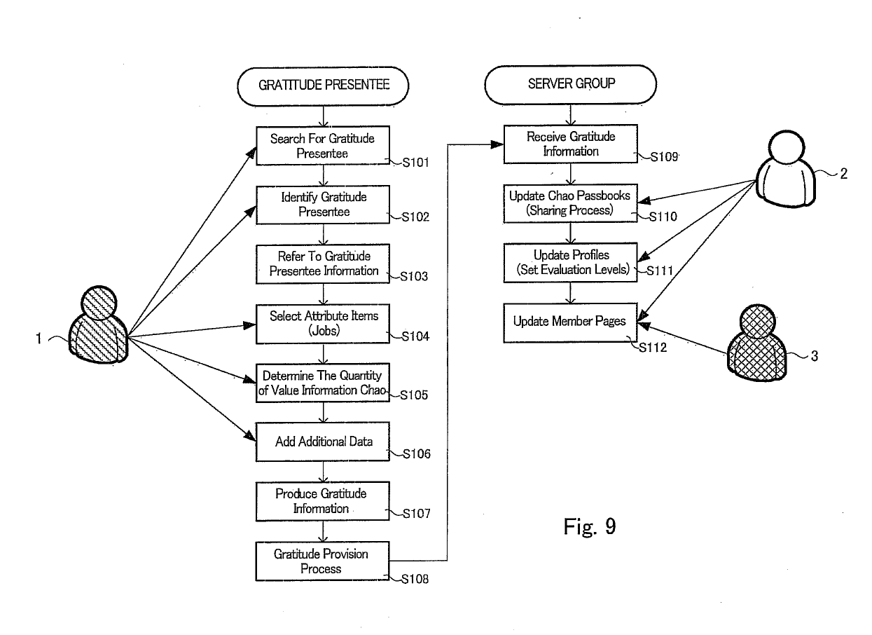

The method of providing gratitude in accordance with the present invention can be implemented by operating the gratitude providing system having the structure as described above. FIG. 9 is a flow chart for showing the operation of the gratitude providing system in accordance with the present embodiment.

In this case, an example will be explained in the case where value information chao is given to represent the feeling of gratitude such as “thank you” for kindness given from the user 2 to the user 1.

First, the user 1 identifies the attribute items of the user 2 who is the gratitude presentee through the communication terminal device 1a which is a gratitude providing unit, and transmits a predetermined quantity of value information which is determined by the user 1.

More specifically speaking, the user 1 identifies a gratitude presentee by inputting the identification information such as an account number or the like of the user 2 as the gratitude presentee in step S102. At this time, if the user 1 does not know an account number or the like of the gratitude presentee, keyword searches can be performed to identify the gratitude presentee in step S101.

When the account number is input, the gratitude presentee information referring unit 103f refers to the user management database 54 through the server group 5 in step S103, and acquires the jobs of the user 2 as the gratitude presentee. A job associated with the gratitude is selected from among these jobs of the user 2 as acquired in step S104. Next, the quantity of chao relating to gratitude is input in step S105. At this time, character data and image data may be added as additional data if necessary in step S106. The gratitude information producing unit 103c joins the above information together to generate and transmit gratitude information to the server group 5 in steps S107 and S108.

The server group 5 then updates the chao passbooks of the users having exchanged the gratitude to reflect the received gratitude information in the user management database 54 in steps S109 and S110. In particular, the passbook management unit 502 records and holds the value information chao, which is received and owned by the user 2, in the chao passbook in association with the job which belongs to the user 2 and selected by the user 1.

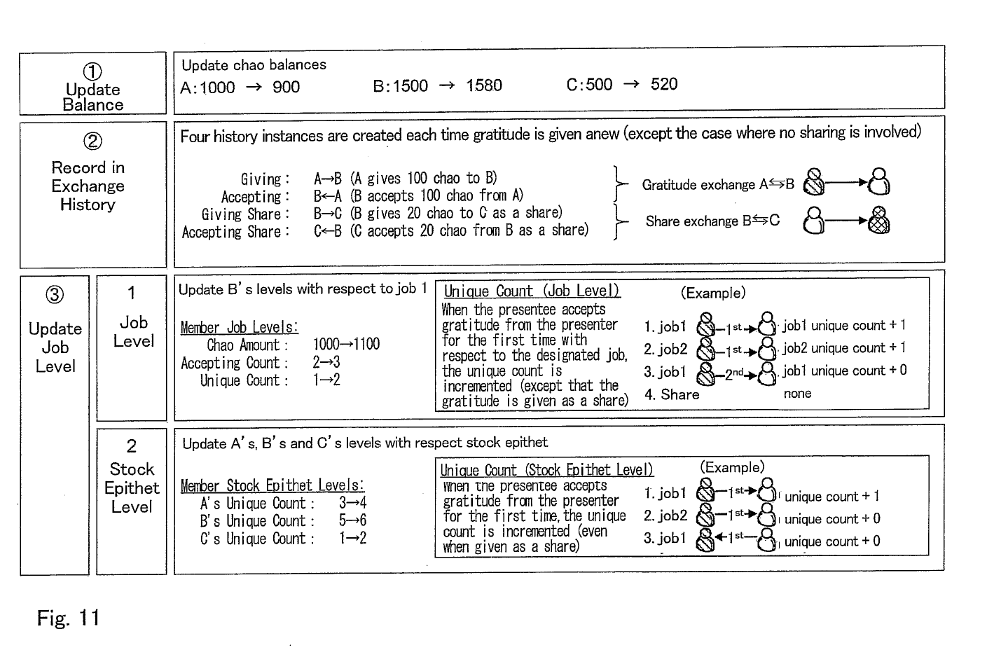

More specifically speaking, as illustrated in FIG. 11, while the balance of “Mr. A (user 1)” who has given gratitude is reduced, the balance of “Mr. B (user 2)” who has accepted gratitude is increased by the quantity of gratitude from which the sharing quantity is deducted. On the other hand, the balance of “Mr. C (another user)” who has accepted the sharing quantity is also increased by the sharing quantity. These transactions are recorded as transaction history. The chao passbooks which are updated as described above can be freely accessed by the respective users in accordance with the publication settings of the user 2.

After chao has been exchanged among the respective users as described above, the job levels and the stock epithet levels which are the evaluation levels of the respective users are updated in step S111 by the profile management unit 501 in accordance with the jobs of the respective users and the quantity and gratitude acceptance frequency of chao associated with each job which are recorded and held by the passbook management unit 502 (the user management database 54). More specifically speaking, with reference to “Mr. B (user 2)” who has accepted gratitude, the updating is performed by increasing the level of the job, which increases in money amount by accepting gratitude, and the number of times of accepting gratitude, as illustrated in FIG. 11, Also, when the user 1 gives the user 2 gratitude for the first time, a new link is formed between the user 1 and the user 2 so that the number of unique users of each of the user 1 and the user 2 is counted up. In this case, the number of unique users of Mr. C who has accepted the sharing quantity is not counted up.

Then, since the number of unique users is counted up, the stock epithet level of each of the user 1 and the user 2 is also counted up. In the case of the present embodiment, with respect to the stock epithet level, the number of unique users of Mr. C who has accepted the sharing quantity is counted up.

Next, the user page publishing unit 506 reflects the job levels of the respective users updated by the profile management unit 501 in the member pages, and publishes the member pages through the communication network in step S112. The published member page can be freely accessed by the users in the world.

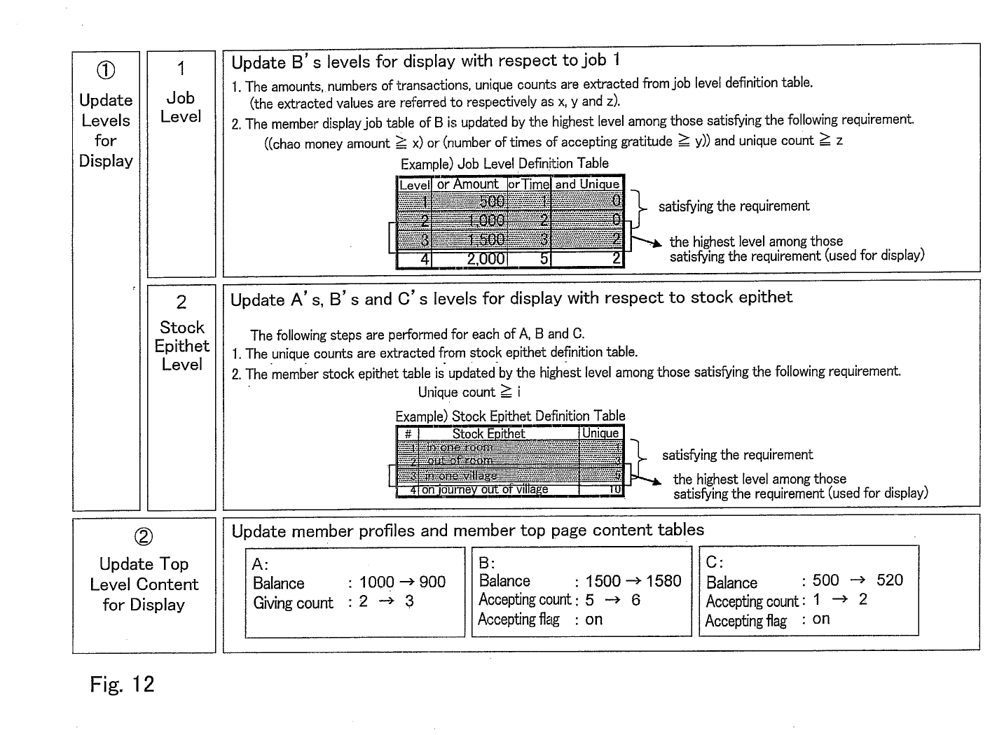

More specifically speaking, as illustrated in FIG. 12, the data displayed as the title of the member pages is updated in accordance with the variation of the evaluation levels (the job levels and stock epithet levels) which are updated in step S111. In this case, since the money amount of chao is increased in relation to the user 2 (Mr. B), the job levels are updated only in relation to the user 2. When updating these levels for display, the levels are sorted with respect to the jobs of which the number of unique users is no lower than a predetermined number and which is associated with the money amount of chao no lower than a predetermined value or associated with the number of times of accepting gratitude no lower than a predetermined value, and the job having the highest level is displayed. With respect to the stock epithet level, since all the users involved in this gratitude transaction (i.e., A, B and C) have the number of unique users increased, the levels to be displayed of all the users are updated, and the stock epithet levels are extracted in correspondence with the largest number of unique users. The content displayed in the top page of the member pages (member profiles) is updated in accordance with the updated levels to be displayed.

(Actions/Effects of Gratitude Providing System and Method)

In accordance with the gratitude providing system and gratitude providing method of the present embodiment as has been discussed above, it is possible to express the feeling of gratitude such as routinely saying “thank you” by the value information chao to the gratitude presentee. Then, by accumulating given chao in the passbook management unit 502, the user having accepted gratitude can be evaluated on the basis of the jobs and the quantity and gratitude acceptance frequency of chao as accumulated. This evaluation is published by the user page publishing unit 506 as the job levels through the communication network 4, and thereby the exchange of the feeling of “thank you” accumulated on an individual basis is internationally published as global information to increase the possibility that “dreams” and “wishes” of users come true.

As a result, in accordance with the present embodiment, while the feeling of gratitude such as saying “thank you” to someone who has given an impressive or kind act in the real world is exchanged and stored in the form of visual value information chao, the links among users can be globally developed, and the closely related links represent the evaluation of the users themselves, such that “dreams”, “wishes” and “something wanted to do” of the users can be realized.

What is claimed is:

1. A gratitude providing system among users for giving visual value information representing the feeling of gratitude to another user who has given an impressive or kind act, said system comprising:
a gratitude providing unit which is a communication terminal used by each user and serves to transmit a predetermined quantity of value information which is determined by identifying attribute items which belong to the another user as a gratitude presentee;
a passbook management unit located in a communication network, and operable to record and hold the value information given and accepted among the users through the gratitude providing unit in association with the attribute items belonging to the respective users;
a profile management unit located in the communication network, and operable to set the attribute item of each user and the evaluation level of each user in accordance with the gratitude acceptance frequency and the quantity of the value information in association with the attribute item, or the number of users involved in the exchange of the value information, as recorded and held in the passbook management unit; and
a user page publishing unit operable to publish the evaluation levels of the respective users which are set by the profile management unit through the communication network.

2. The gratitude providing system as claimed in claim 1 wherein, when the value information is transmitted, the gratitude providing unit can add additional data such as character data, image data or the like.

3. The gratitude providing system as claimed in claim 1 further comprising:
a value information purchase unit operable to sell the value information through the communication network, make the gratitude providing unit accumulate the value information, and perform a billing process corresponding to the sales of value information.

4. The gratitude providing system as claimed in claim 1 further comprising:
a search unit operable to search the pages of the users with the evaluation levels and other profiles of the users as search terms.

5. The gratitude providing system as claimed in claim 1 wherein the value information has a value which is exchangeable with goods or services.

6. A gratitude providing method among users for giving visual value information representing the feeling of gratitude to another user who has given an impressive or kind act, said method comprising:
transmitting a predetermined quantity of value information which is determined by identifying attribute items belonging to the another user as a gratitude presentee through a gratitude providing unit which is a communication terminal used by each user;
recording and holding the value information given and accepted among the users through the gratitude providing unit in association with the attribute items belonging to the respective users by a passbook management unit located in a communication network;
setting the attribute item of each user and the evaluation level of each user in accordance with the gratitude acceptance frequency and the quantity of the value information in association with the attribute item, or the number of users involved in the exchange of the value information, as recorded and held in the passbook management unit, a profile management unit located in the communication network; and
publishing the evaluation levels of the respective users which are set by the profile management unit through the communication network by a user page publishing unit.

7. The gratitude providing method as claimed in claim 6 wherein, when the value information is transmitted, the gratitude providing unit can add additional data such as character data, image data or the like.

8. The gratitude providing method as claimed in claim 6 further comprising:
selling the value information through the communication network, making the gratitude providing unit accumulate the value information, and performing a billing process corresponding to the sales of value information.

9. The gratitude providing method as claimed in claim 6 further comprising:
searching the pages of the users by a search unit with the evaluation levels and other profiles of the users as search terms.

10. The gratitude providing method as claimed in claim 6 wherein the value information has a value which is exchangeable with goods or services.
